(19) United States
(12) Patent Application Publication
(10) Pub. No.: US 2009/0083938 A1
(43) Pub. Date: Apr. 2, 2009

(54) Double-Pedal Double Wheel Truckle with Independent Braking and Releasing Functions

(76) Inventor: Qing-Song LIN, Yunlin County (TW)

Correspondence Address: Dr. BANGER SHIA, 102 Lindencrest Ct., Sugar Land, TX, 77479-5201, US

(21) Appl. No.: 11/862,637

(22) Filed: Sep. 27, 2007

(51) Int. Cl. B60B 33/00

(52) U.S. Cl. 16/47

(57) ABSTRACT

A double-pedal double-wheel truckle with independent braking and releasing functions is a truckle for a precision instrument and comprises a body, a rotating & locking device, a truckle body device, a braking device and a bottom cover body. The body is provided for disposing a rotating & locking device, a truckle body device, a braking device and a bottom cover body. With the independent braking and releasing functions of the braking device of the body, the user can easily operate and stably block the rotating & locking device and the truckle body device. The bottom cover body is provided for preventing foreign matters from entering inside the truckle body device, so that the truckle suitable for a precision instrument can keep a stable and safe static state. By such arrangements, it can achieve the objectives, such as easy operation, easy to distinguish braking state, stable braking, reducing noises, strengthening structure and safe usage, etc.

### BACKGROUND OF THE INVENTION

1. Field of the Invention

The present invention relates to a truckle with braking and releasing functions, and more particularly to a truckle with independent braking and releasing functions suitable for a precision instrument, which utilizes a braking device to provide the user the functions, such as easy operation, easy to distinguish the braking state, stable braking, avoiding noises and safe usage, etc.

2. Description of the Prior Art

A conventional truckle structure disclosed in Taiwan Design Patent No. 339,043 is an improvement of a truckle structure. On the top of the truckle rack of this truckle structure is disposed a holding platform. A braking device is suspended from the front end of the holding platform. The holding platform includes opposite through holes in both side boards thereof, at least one pivot hole in the protruding ear at the front end of each side board, at least one fastening portion inside each side board adjacent to the protruding ear. The fastening portion includes a longitudinal end board forming on the inside surface of the side board adjacent to the protruding ear. The tip end of the longitudinal end board extends backward out of a side stopping board. A transverse engaging block is disposed in a region surrounded by the longitudinal end board and the side stopping board. In addition, a fastener is disposed on the side board.

The above conventional truckle structure has the following disadvantages:

1. Difficult to operate: the braking structure of the braking device is integrated with the releasing structure. By such a design, the braking operation and the releasing operation cannot be substantially achieved. Thereby, it cannot provide an easy operation and high safety;

2. Cost wasting: the braking device is suspended form the front end of the holding platform, and such a design is a two-segment design and is unlikely to be an integrated structure, so it is required to additionally manufacture the braking component after the holding platform is completed, thus increasing a manufacturing process and causing the material waste;

3. Difficult to manufacture: On the top of the truckle rack is disposed a holding platform. The holding platform includes opposite through holes in both side boards thereof, at least one pivot hole in the protruding ear at the front end of each side board, at least one fastening portion inside each side board adjacent to the protruding ear and a longitudinal end board forming on the inside surface of the side board adjacent to the protruding ear. The tip end of the longitudinal end board extends backward out of a side stopping board. In a region surrounded by the longitudinal end board and the side stopping board is disposed a transverse engaging block. The highly complicated side board is difficult to manufacture.

4. Truckle deformation: since the braking device of the holding platform directly presses against the truckle body and a pivot rotating position, such a braking action is likely to cause the deformation of the truckle body.

5. Easy damage: on the top of the truckle are disposed a holding platform and the side boards of the holding platform, etc, so the assembled truckle rack needs to support the structures of the holding platform, etc, thus improving the damage rate of the truckle rack.

6. Poor stability: the braking structure is integrated with the releasing structure of the braking device, by such a design, when in use, the user is likely to synchronously perform the braking action and the releasing action, thus causing the poor operational stability.

The present invention has arisen to mitigate and/or obviate the afore-described disadvantages.

### SUMMARY OF THE INVENTION

The present invention relates to a double-pedal double-wheel truckle with independent braking and releasing functions. The truckle is suitable for a precision instrument and comprises a body. The body is provided for disposing a rotating & locking device, a truckle body device and a braking device. The braking device is disposed in the middle of the rotating & locking device and the truckle body device. With the above integral structure, it can achieve the objectives of easy operation, easy to distinguish the braking state, stable braking, reducing noises, strengthening structure and safe usage, etc.

The present invention further relates to a double-pedal double-wheel truckle with independent braking and releasing functions. The truckle is suitable for a precision instrument and comprises a body. With the braking and releasing functions of a braking device of the body, the rotating & locking device and the truckle body device can be firmly positioned, and the user can easily distinguish the braking state, operate and stably block the truckle through the braking device, so as to keep the truckle suitable for the precision instrument in a safe static state, thus achieving the objectives of easy operation, easy to distinguish the braking state, stable braking and safe usage, etc.

### BRIEF DESCRIPTION OF THE DRAWINGS

FIG. 1 is a perspective view of a double-pedal double-wheel truckle with independent braking and releasing functions in accordance with the present invention;

FIG. 2 is an exploded view of the double-pedal double-wheel truckle with independent braking and releasing functions in accordance with the present invention;

FIG. 3 is a cross sectional view of the double-pedal double-wheel truckle with independent braking and releasing functions in accordance with the present invention;

FIG. 4 is a perspective view showing that the double-pedal double-wheel truckle with independent braking and releasing functions in accordance with the present invention is operated; and

FIG. 5 is a cross sectional view showing the double-pedal double-wheel truckle with independent braking and releasing functions in accordance with the present invention is operated.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

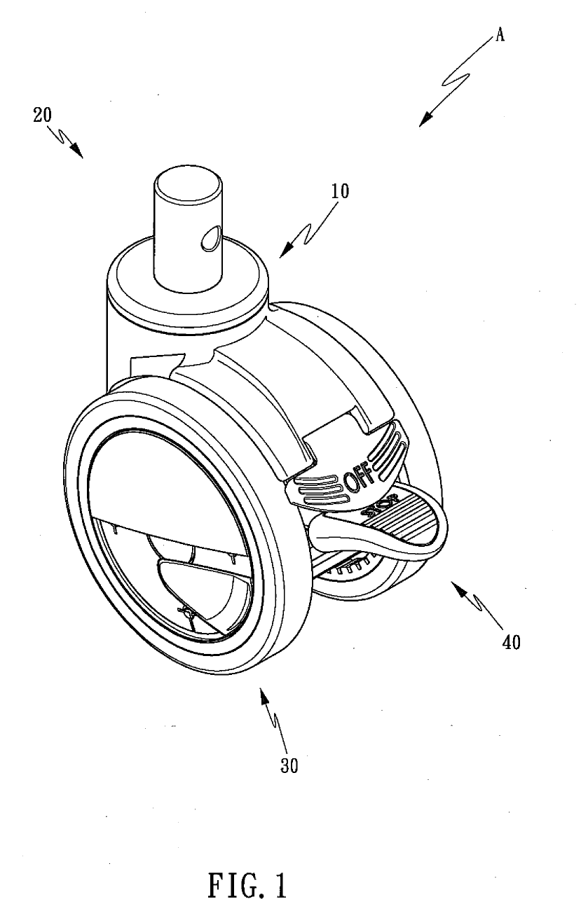

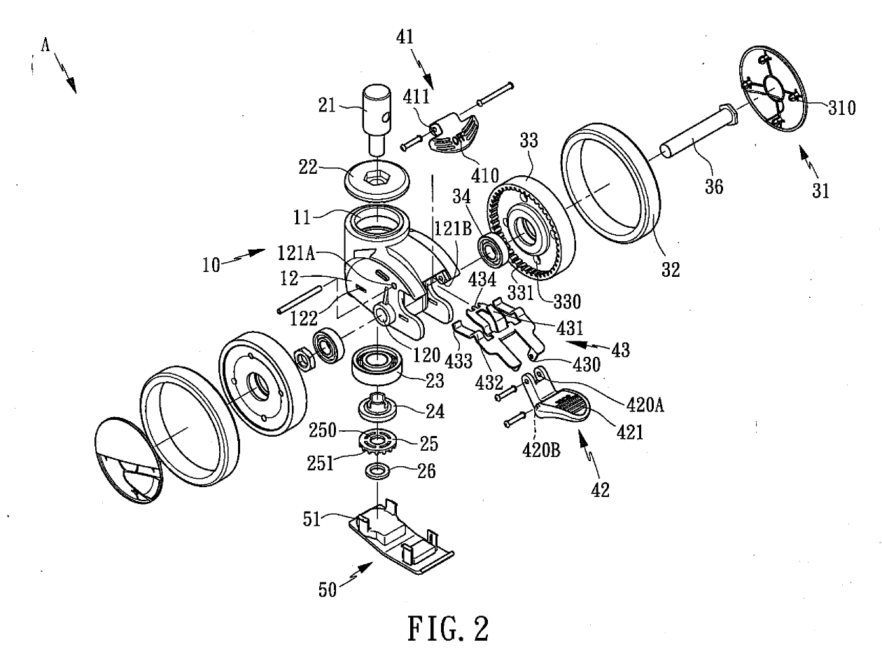

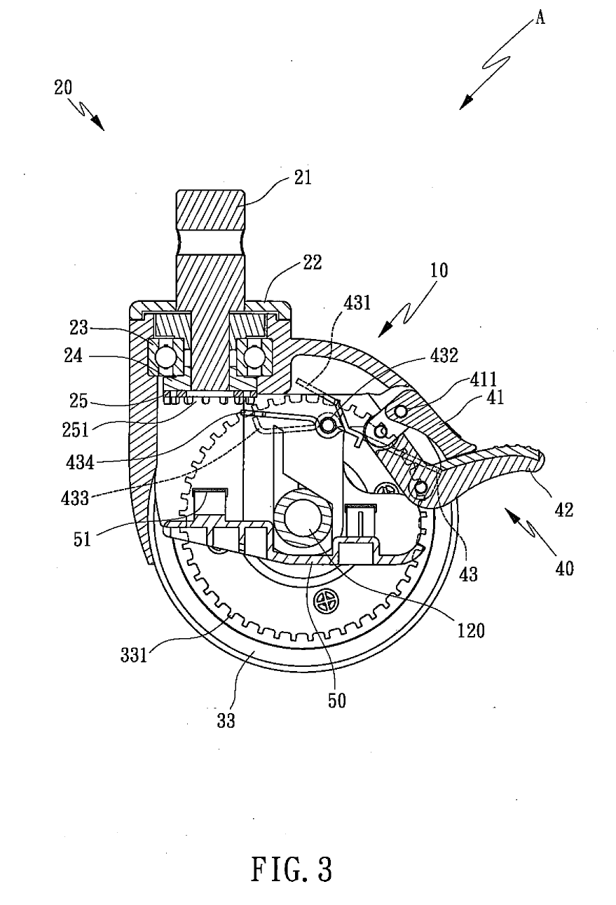

Referring to FIGS. 1-5, a double-pedal double-wheel truckle A with independent braking and releasing functions in accordance with the present invention, which is suitable for a precision instrument, comprises a slide-shaped body 10 disposed with a plurality of inserting-receiving configurations. The body 10 includes a rotating & locking device 20, a truckle body device 30, a braking device 40 and a bottom cover body 50. The braking device 40 is disposed between the rotating & locking device 20 and the truckle device 30 of the body 10. The bottom cover body 50 is disposed at one end of the rotating & locking device 20 and the truckle body device 30 for preventing foreign matters from entering inside. With the braking and releasing functions of the braking device 40 of the body 10, the user can easily operate and stably block the rotating & locking device 20 and the truckle body device 30. Additionally, the bottom cover body 50 is used to prevent foreign matters form entering inside, so that the truckle A suitable for a precision instrument can be stably actuated, safely moved or kept a safe static state. By such arrangements, the present invention can achieve the objectives, such as easy operation, easy to distinguish braking state, stable braking, reducing noises, strengthening structure and safe usage, etc.

The body 10 is a slide-shaped body including a plurality of inserting-receiving configurations. One end of the body 10 is disposed with a through round receiving portion 11 of a big diameter for holding the rotating & locking device 20. Adjacent to the receiving portion 11 is disposed a matching body 12 with opposite arc-shaped members. The matching body 12 includes a round receiving hole 120 and a plurality of round through holes 121A, 121B of a small diameter and a plurality of elongated fastening holes 122. The receiving hole 120 is provided for insertion of the truckle body device 30, and the holes 121 A, 121B are provided for the insertion of the braking device 40. The fastening hole 122 is provided for the insertion of the bottom cover body 50.

The rotating and locking device 20 includes a stepped column-shaped inserting member 21, a disc-shaped hollow matching member 22, a round bearing member 23, at least more than one round hollow washer member 24, a disk-shaped multi-tooth fastening member 25 and a round hollow fixing member 26. One end of the inserting member 21 is fixed to the precision instrument, and the other smaller end of the inserting member 21 is inserted into the matching member 22, the bearing member 23, and the washer member 24. A free end of the inserting member 21 is disposed in the fastening member 25. The matching member 22 is covered outside the receiving portion 11 and includes an inserting portion 220. The inserting portion 220 is inserted through the center of the bearing member 23. The bearing member 23 is positioned in the receiving portion 11 and a round stepped washer member 24, and the other end of the washer member 24 is disposed with the fastening member 25. The fastening member 25 includes a cross-shaped receiving hole 250 for receiving the inserting member 21, and a multi-tooth inside-concave fastening portion 251 for fastening with the braking device 40. The fixing member 26 is fixed to one end of the inserting member 21.

The truckle body device 30 includes at least more than one pair of round shield-shaped shell members 31, at least more than one pair of round wheel-shaped wheels 32, at least more than one pair of disc-shaped multi-level driven members 33, at least more than one pair of round bearing members 34 and a solid column-shaped middle shaft 36. The shell member 31 is vertically disposed with at least more than one round protruding engaging portion 310 with a cross groove. The protruding engaging portion 310 is disposed in the driven member 33. Additionally, the wheel 32 is mounted on a rounding outer end of the driven member 33 for facilitating the wheel 32 freely rotating around the free end of the driven member 33. The driven member 33 includes a plurality of engaging holes 330 engaged with the protruding engaging portions 310 of the shell member 31 and a plurality of tooth-shaped engaging portions 331. The engaging portions 331 are provided for engaging with the baking device 40. In addition, the bearing member 34 is positioned outside the matching body 12 and in the hollow position of the driven member 33. The middle shaft 36 is inserted through the matching body 12 and the bearing member 34 for restricting the deviation of the bearing member 34.

The braking device 40 includes a mushroom-shaped releasing member 41, a <-shaped actuating member 42 and a flexuous chip-shaped releasing & stopping member 43. One end of the releasing member 41 is disposed with a releasing portion 410 including a plurality of symmetrical parallel antiskid ribs for the user to step on without slippage, and the other end of the releasing member 41 is disposed with a through connecting hole 411 for pivotally coupling the pivot shaft to the actuating member 42 and the holes 121A of the matching body 12. One end of the actuating member 42 includes a plurality of through coupling holes 420A, 420B, and the other end of the actuating member 42 includes an actuating portion 410 with a plurality of antiskid parallel ribs for the user to step on without slippage. The through coupling holes 420A and the through connecting hole 411 of the releasing member 41 are provided for the insertion of the pivot shaft, and then the pivot shaft will be pivotally coupled to the holes 121B of the matching body 12. The through coupling hole 420B is disposed at one end of the releasing &stopping member 43 and provided for connecting with a pivot shaft. The releasing & stopping member 43 is disposed with a matching portion 430 with two opposite round holes, an arc-shaped elastic return member 431, a fastening portion 432 with two opposite three-quarter circles, an abutting engaging portion 433 with two opposite vertical chips and an abutting fastening portion 434 with two opposite vertical chips. A pivot shaft is inserted through matching portion 430 and the through coupling hole 420B of the actuating member 42, and the elastic return member 431 is disposed in the middle of the fastening portion 432 and supports against the internal end surface of the matching body 12. The fastening portion 432 is disposed with the round through holes 121A, 121B of the matching body 12 for inserting a pivot rod. The abutting engaging portion 433 and the abutting fastening portion 434 can be positioned against the fastening portion 251 of the fastening member 25 of the rotating & locking device 20 and the engaging portion 331 of the driven member 33 of the truckle body device 30 by cooperating with the braking or releasing action of the releasing member 41 and the driven member 42.

The bottom cover body 50 is an integrated chip body with a fastening portion 51, which extends adjacent to the body 10. The fastening portion 51 is fastened to the fastening hole 122 of the body 10. By firmly fastening the fastening portion 51 of the bottom cover body 50 with the fastening hole 122 of the body 10, it can prevent the foreign matters from blocking the actuation of the truckle body device 30.

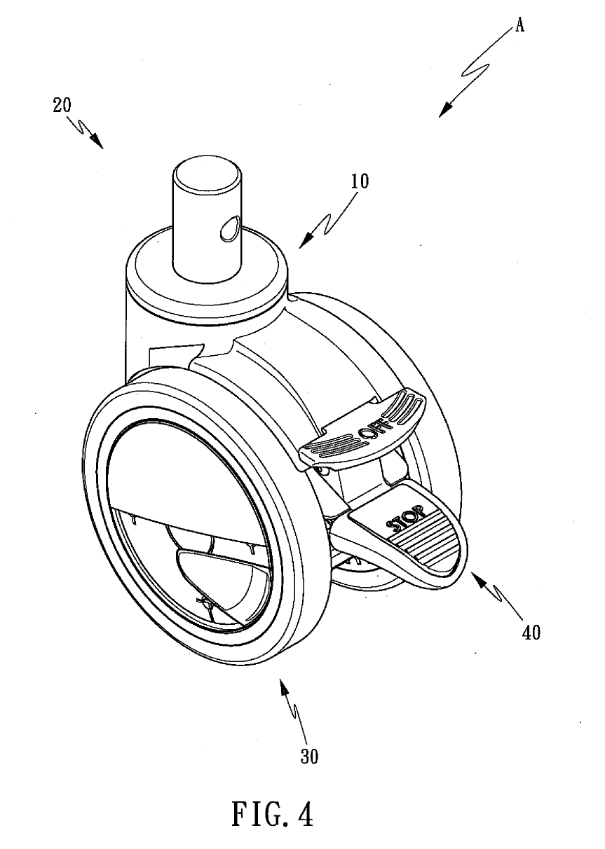

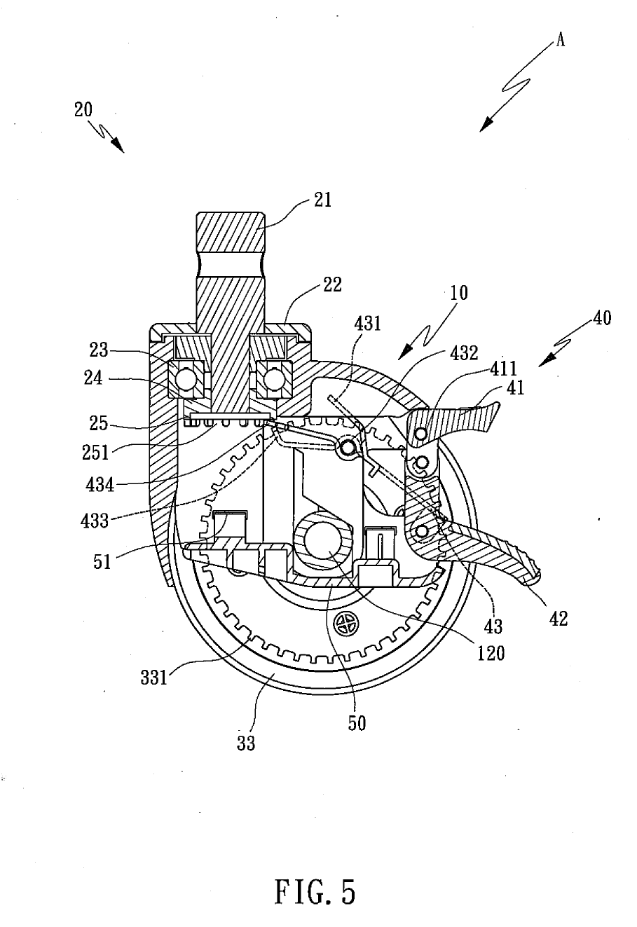

Further referring to FIGS. 4-5, when the user steps on the actuating member 42 of the braking device 40, and the actuating member 42 linked with the releasing &stopping member 43 will drive the releasing member 41 to make the abutting engaging portion 433 of the releasing &stopping member 43 engage with the engaging portion 331 of the driven member 33 of the truckle body device 30, and the abutting fastening portion 434 be fastened to the fastening portion 251 of the fastening member 25 of the rotating & locking device 20. By such arrangements, the rotating & locking device 20 and the truckle body device 30 can form a stable and safe static state. The releasing member 41 and the actuating member 42 of the braking device 40 keep a vertical separation state in use, thus facilitating the user distinguishing the braking state, safely operating and braking the braking device 40. Thereby, the truckle A suitable for a precision instrument can provide the functions such as an easy operation, easy to distinguish the braking state, a stable braking and a safe usage, etc, thus achieving the objectives of saving the material cost and shortening the manufacturing time.

With the above structures, the present invention can provide the following functions, such as:

1. Easy operation: when the user steps on the actuating member 42 of the braking device 40, the actuating member 42 linked with the releasing &stopping member 43 will drive the releasing member 41 to make the abutting engaging portion 433 of the releasing &stopping member 43 substantially engage with the engaging portion 331 of the driven member 33 of the truckle body device 30, and the abutting fastening portion 434 be substantially fastened to the fastening portion 251 of the fastening member 25 of the rotating & locking device 20, thus forming a stable and safe static state. By such a design, the user can definitely operate the braking and releasing actions. Thereby, the present invention can really offer the functions of easy operation and safety;

2. Cost saving: the releasing member 41 and the actuating member 42 of the braking device 40 provided for the user to step on are pivotally coupled to the releasing & stopping member 43 and the matching body 12 of the body 10, respectively. By such a pivot design of a simplified linkage structure, it is not required to additionally add a manufacturing process, thus saving the cost;

3. Components are difficult to damage: the releasing member 41, the actuating member 42 and the releasing & stopping member 43 of the braking device 40 provided for the user to step on are pivotally coupled to the through holes 121 A, 121 B and the receiving hole 120 of the matching body 12, and the releasing member 41 and the actuating member 42 are pivotally coupled to the releasing & stopping member 43 to link each other. By such a design, the applied force is dispersed, and thus it is unlikely to increase the damage rate of the body structure of the truckle;

4. Fine stability and easy to distinguish: when the user step on the actuating member 42 of the braking device 40, the actuating member 42 linked with the releasing & stopping member 43 will drive the releasing member 41, and the actuating member 42 and the releasing member 41 are vertically separated. By such a design, it can provide the user the advantages, easy to distinguish the braking and releasing states, stable braking, thus offering the functions, easy to distinguish and fine stability;

5. Easy to manufacture: the releasing member 41, the actuating member 42 and the releasing & stopping member 43 of the braking device 40 provided for the user to step on, are made by injection molding or extrusion. By such a design, it is easy to manufacture the braking device 40;

6. Stable actuation: the bottom cover body 50 is an integrated chip body, and the bottom cover body 50 is disposed with a plurality of fastening portions 51 to fasten with the fastening holes 122 of the body 10. By such a design, the bottom cover body 50 can be firmly fastened to the body 10 to prevent the foreign matters from blocking the actuation of the truckle body device 30.

While we have shown and described various embodiments in accordance with the present invention, it is clear to those skilled in the art that further embodiments may be made without departing from the scope of the present invention.

What is clamed is:

1. A double-pedal double-wheel truckle with independent braking and releasing functions suitable for a precision instrument, comprising: a body, a rotating & locking device, a truckle body device, and a braking device; wherein:
the body is provided for disposing the rotating & locking device, the truckle body device and the braking device;
the rotating & locking device includes a fastening member which is disposed at one end of the body and provided for fastening with the braking device;
the truckle body device is disposed at both sides of the body for engaging with the braking device;
the braking device includes a releasing member, an actuating member, and a releasing & stopping member, the releasing member is pivotally coupled in the body, and one end of the releasing member is disposed with a releasing portion, the actuating member is pivotally disposed in the body, and one end of the actuating member is disposed with an actuating portion, both the releasing portion of the releasing member and the actuating portion of the actuating member extend outside the body for the user to actuate, the other end of the releasing member and the other end of the actuating member are pivotally coupled to the releasing & stopping member in the body, the other end of the releasing & stopping member is pivotally coupled in the body and extended with an abutting engaging portion and an abutting fastening portion toward the fastening member of the rotating & locking device and one end of the truckle body device, when the releasing portion of the releasing member and the actuating portion of the actuating member are actuated, the abutting engaging portion and the abutting fastening portion synchronously release or fasten the fastening member of the rotating & stopping device and the truckle body device.

2. The double-pedal double-wheel truckle with independent braking and releasing functions as claimed in claim 1, wherein the body includes a receiving portion, and a plurality of matching bodies, the receiving portion is provided for disposing the rotating & locking device, each matching body is disposed adjacent to the receiving portion of the body and includes a receiving hole, a plurality of through holes and a plurality of fastening holes, the receiving hole of each matching body is provided for disposing the truckle body device, the through holes of each matching body are provided for disposing the braking device, and the fastening holes are provided for fastening with a bottom cover body.

3. The double-pedal double-wheel truckle with independent braking and releasing functions as claimed in claim 1, wherein the rotating & locking device includes an inserting member, a matching member, a bearing member, at least one washer member, and a fastening member, one end of the inserting member of the rotating & locking device is disposed in the precision instrument, and the other end of the inserting member of the rotating & locking device is inserted through the matching member, the bearing member, the washer member and the fastening member, the matching member is mounted outside the receiving portion and disposed with an inserting portion, the inserting portion of the matching member is inserted through the bearing member, and the bearing member is disposed on one end of the washer member, and the other end of the washer member is disposed with the fastening member, and the fastening member is disposed with a receiving hole for an insertion of the inserting member, and a fastening portion for fastening with the braking device.

4. The double-pedal double-wheel truckle with independent braking and releasing functions as claimed in claim 1, wherein the truckle body device includes at least one pair of shell members, at least one pair of wheels, at least one pair of driven members, at least one pair of bearing members and a middle shaft, the shell members, the wheels and the bearing members are disposed at one end of the driven member, and the middle shaft is inserted through the matching bodies and the bearing members of the truckle body device for restricting a deviation of the bearing members of the truckle body device, each shell member includes at least one protruding engaging portion which is fastened to the driven member, and each wheel is mounted on each driven member, each driven member includes a plurality of engaging holes used to engage with the protruding engaging portions of each shell member, and a plurality of tooth-shaped engaging portions used to engage with the braking device, each bearing member of the truckle body device is disposed outside each matching body and in a hollow position of each driven member, the middle shaft is inserted through the body and the bearing members of the truckle body device for restricting a deviation of the bearing members of the truckle body device.

5. The double-pedal double-wheel truckle with independent braking and releasing functions as claimed in claim 1, wherein the braking device includes a releasing member, an actuating member and a releasing & stopping member, the releasing member and the actuating member are pivotally coupled to the releasing includes a & stopping member and the body, the releasing member is disposed with a through connecting hole for pivotally coupling a pivot shaft to the driven member and the body, the actuating member is disposed with more than a pluralityof through coupling holes which are used together with the through connecting holes of the releasing member for inserting a pivot shaft, the through coupling holes of the actuating member are used for pivotally coupling the releasing & stopping member.

6. The double-pedal double-wheel truckle with independent braking and releasing functions as claimed in claim 5, wherein the releasing & stopping member includes a matching portion, an elastic return member, a fastening portion, an abutting engaging portion and an abutting fastening portion, a pivot shaft is inserted through the matching portion of the releasing & stopping member and the through coupling holes of the actuating member, and the elastic return member is disposed in the middle of the fastening portion of the releasing & stopping member and supports against the body, the fastening portion of the rotating & locking member is disposed in the body for an insertion of a pivot rod.

7. A double-pedal double-wheel truckle with independent braking and releasing functions as claimed in claim 1, wherein the body is disposed with a plurality of fastening holes for fastening with a bottom cover body, and the bottom cover body includes a plurality of fastening portions for fastening with the fastening holes of the body.

8. A double-pedal double-wheel truckle with independent braking and releasing functions suitable for a precision instrument, comprising: a body, a rotating & locking device, a truckle body device, and a braking device; wherein:
the body is provided for disposing the rotating & locking device, the truckle body device and the braking device;
the rotating & locking device includes a fastening member which is disposed at one end of the body and provided for fastening with the braking device;
the truckle body device includes at least one pair of driven members which are disposed at both sides of the body, one end of each driven member is provided for abutting against the braking device;
the braking device includes a releasing member, an actuating member, and a releasing & stopping member, the releasing member is pivotally coupled in the body, and one end of the releasing member is disposed with a releasing portion, the actuating member is pivotally disposed in the body, and one end of the actuating member is disposed with an actuating portion, both the releasing portion of the releasing member and the actuating portion of the actuating member extend outside the body for the user to actuate, the other end of the releasing member and the other end of the actuating member are pivotally coupled to the releasing & stopping member in the body, the other end of the releasing & stopping member is pivotally coupled in the body and extended with an abutting engaging portion and an abutting fastening portion toward the fastening member of the rotating & locking device and one end of the truckle body device, when the releasing portion of the releasing member and the actuating portion of the actuating member are actuated, the abutting engaging portion and the abutting fastening portion synchronously release or fasten the fastening member of the rotating & stopping device and the driven members of the truckle body device.

9. The double-pedal double-wheel truckle with independent braking and releasing functions as claimed in claim 8, wherein the body includes a receiving portion, and a plurality of matching bodies, the receiving portion is provided for disposing the rotating & locking device, each matching body is disposed adjacent to the receiving portion of the body and includes a receiving hole, a plurality of through holes and a plurality of fastening holes, the receiving hole of each matching body is provided for disposing the truckle body device, the through holes of each matching body are provided for disposing the braking device, and the fastening holes are provided for fastening with fastening portions of a bottom cover body.

10. The double-pedal double-wheel truckle with independent braking and releasing functions as claimed in claim 8, wherein the rotating & locking device includes an inserting member, a matching member, a round bearing member, at least more than one washer member, and a fastening member, one end of the inserting member of the rotating & locking device is disposed in the precision instrument, and the other end of the inserting member of the rotating & locking device is inserted through the matching member, the bearing member, the washer member and the fastening member, the matching member is disposed at the receiving portion and disposed with an inserting portion, the inserting portion of the matching member is inserted through a center of the bearing member, and the bearing member is disposed in the receiving portion and disposed with more than one washer member, and the other end of the washer member is disposed with the fastening member, and the fastening member is disposed with a receiving hole for an insertion of the inserting member, and a fastening portion for fastening with the braking device.

11. The double-pedal double-wheel truckle with independent braking and releasing functions as claimed in claim 8, wherein the truckle body device includes at least more than one pair of shell members, at least more than one pair of wheels, at least more than one pair of driven members, at least more than one pair of bearing members and a middle shaft, the shell members, the wheels and the bearing members are disposed at the driven member, and the middle shaft is inserted through the matching bodies and the bearing members of the truckle body device for restricting a deviation of the bearing members of the truckle body device, each shell member includes at least more than one protruding engaging portion which is fastened to the driven member, and each wheel is mounted on a rounding free end of each driven member, each driven member includes an engaging hole used to engage with the protruding engaging portion of each shell member, and a plurality of tooth-shaped engaging portions used to engage with the braking device, each bearing member of the truckle body device is disposed outside each matching body and in a hollow position of each driven member, the middle shaft is inserted through the body and the bearing members of the truckle body device for restricting the deviation of the bearing members of the truckle body device.

12. The double-pedal double-wheel truckle with independent braking and releasing functions as claimed in claim 8, wherein the braking device includes a releasing member, an actuating member and a releasing & stopping member, the releasing member and the actuating member are pivotally coupled to the releasing & stopping member and the body, the releasing member is disposed with a through connecting hole for pivotally coupling a pivot shaft to the driven member and the body, the actuating member is disposed with more than a plurality of through coupling holes which are used together with the through connecting holes of the releasing member for inserting a pivot shaft, the through coupling holes of the actuating member is used for pivotally coupling the releasing & stopping member.

13. The double-pedal double-wheel truckle with independent braking and releasing functions as claimed in claim 12, wherein the releasing & stopping member includes a matching portion, an elastic return member, a fastening portion, an abutting engaging portion and an abutting fastening portion, a pivot shaft is inserted through the matching portion of the releasing & stopping member and the through coupling holes of the actuating member, and the elastic return member is disposed in the middle of the fastening portion of the releasing & stopping member and supports against an inner end surface of the body, the fastening portion of the rotating & locking member is disposed in the body for an insertion of a pivot rod, the abutting engaging portion and the abutting fastening portion are positioned against the fastening portion of the fastening member of the rotating & locking device and the engaging portion of the driven member of the truckle body device by cooperating with a braking or releasing action of the releasing member and the actuating member.

14. A double-pedal double-wheel truckle with independent braking and releasing functions suitable for a precision instrument, comprising: a body, a rotating & locking device, a truckle body device, and a braking device; wherein:
the body includes a receiving portion, a plurality of matching bodies, the receiving portion is provided for disposing the rotating & locking device, each matching body is disposed adjacent to the receiving portion of the body and includes a receiving hole, and a plurality of through holes, the receiving hole of each matching body is provided for disposing the truckle body device, the through holes of each matching body are provided for disposing the braking device;
the rotating & locking device includes an inserting member, a matching member, a round bearing member, at least more than one washer member, and a fastening member, one end of the inserting member of the rotating & locking device is disposed in the precision instrument, and the other end of the inserting member of the rotating & locking device is inserted through the matching member, the bearing member, the washer member and the fastening member, the matching member is mounted outside the receiving portion and disposed with an inserting portion, the inserting portion of the matching member is inserted through a center of the bearing member, and the bearing member is disposed in the receiving portion and disposed with more than one washer member, the other end of the washer member is disposed with the fastening member, and the fastening member is disposed with a receiving hole for an insertion of the inserting member, and a fastening portion for fastening with the braking device;
the truckle body device includes at least more than one pair of shell members, at least more than one pair of wheels, at least more than one pair of driven members, at least more than one pair of bearing members and a middle shaft, the shell members, the wheels and the bearing members are disposed at the driven member, and the middle shaft is inserted through the matching bodies of the body and the bearing members of the truckle body device for restricting a deviation of the bearing members of the truckle body device; and
the braking device includes a releasing member, an actuating member, and a releasing & stopping member, the releasing member is pivotally coupled in the body, and one end of the releasing member is disposed with a releasing portion, the actuating member is pivotally coupled in the body, and one end of the actuating member is disposed with an actuating portion, both the releasing portion of the releasing member and the actuating portion of the actuating member extend outside the body for the user to actuate, the other end of the releasing member is pivotally coupled in the body and extended with an abutting engaging portion and an abutting fastening portion toward the fastening member of the rotating & locking device and one end of the truckle body device, when the releasing portion of the releasing member and the actuating portion of the actuating member are actuated, the abutting engaging portion and the abutting fastening portion synchronously release or fasten the fastening member of the rotating & stopping device and the driven members of the truckle body device.

15. The double-pedal double-wheel truckle with independent braking and releasing functions as claimed in claim 14, wherein each shell member includes at least more than one protruding engaging portion which is disposed in the driven member, and each wheel is mounted on a rounding free end of each driven member, each driven member includes a plurality of engaging holes used to engage with the protruding engaging portions of each shell member and a plurality of tooth-shaped engaging portions used to engage with the braking device, each bearing member of the truckle body device is disposed outside each matching body and in a hollow position of each driven member, and the middle shaft is inserted through the matching bodies and the bearing members for restricting deviation of the bearing members.

16. The double-pedal double-wheel truckle with independent braking and releasing functions as claimed in claim 14, wherein the releasing member and the actuating member of the braking device are pivotally coupled to the releasing & stopping member and in an inner end of the body, the releasing member is disposed with a through connecting hole for pivotally coupling a pivot shaft to the actuating member and the inner end of the body, the actuating member includes a plurality of through coupling holes which are used together with the through connecting hole of the releasing member for an insertion of a pivot shaft, the releasing & stopping portion is for pivotally coupling with the through coupling holes of the actuating member.

17. The double-pedal double-wheel truckle with independent braking and releasing functions as claimed in claim 14, wherein the releasing & stopping member includes a matching portion, an elastic return member, a fastening portion, an abutting engaging portion and an abutting fastening portion, a pivot shaft is inserted through the matching portion of the releasing & stopping member and the through coupling hole of the actuating member, and the elastic return member is disposed in the middle of the fastening portion of the releasing & stopping member and supports against an inner end surface of the matching body of the body, the fastening portion of the rotating & locking member is disposed in the through holes of the matching body for an insertion of a pivot rod, the abutting engaging portion and the abutting fastening portion are positioned against the fastening portion of the fastening member of the rotating & locking device and the engaging portion of the driven member of the truckle body device by cooperating with a braking or releasing action of the releasing member and the actuating member.

18. The double-pedal double-wheel truckle with independent braking and releasing functions as claimed in claim 14, wherein a bottom cover body is disposed between the rotating & locking device and the truckle body device of the body for prevent foreign matters from entering inside.

19. The double-pedal double-wheel truckle with independent braking and releasing functions as claimed in claim 14, wherein the body is provided with a plurality of fastening holes, and the bottom cover body includes a plurality of fastening portions.

20. The double-pedal double-wheel truckle with independent braking and releasing functions as claimed in claim 18, wherein the fastening holes of the body are provided for fastening with the fastening portions of the bottom cover body.
